(19) United States
(12) Patent Application Publication
(10) Pub. No.: US 2010/0126934 A1
(43) Pub. Date: May 27, 2010

(54) PURIFICATION PROCESS OF FLUORINE-BASED SOLVENT-CONTAINING SOLUTION

(76) Inventors: Daisuke Nakazato, Tokyo (JP); Hiromi Kofuse, Tokyo (JP)

Correspondence Address: 3M INNOVATIVE PROPERTIES COMPANY, PO BOX 33427, ST. PAUL, MN, 55133-3427, US

(21) Appl. No.: 12/527,903

(22) PCT Filed: Feb. 4, 2008
(86) PCT No.: PCT/US08/52896

§ 371 Date: Aug. 20, 2009

(30) Foreign Application Priority Data
Feb. 23, 2007 (JP) 2007-044315

(51) Int. Cl. B01D 15/04

(52) U.S. Cl. 210/638; 210/314

(57) ABSTRACT

To provide a purification process where a fluorine-based solvent can be obtained at a high purity by relatively small equipment without using a distillation apparatus. A purification process of a mixed solution containing a fluorine-based solvent which is a process for purifying a fluorine-based solvent from a mixed solution containing a fluorine-based solvent, a water-soluble organic solvent contaminant, an organic contaminant and an ion contaminant, the process comprising: step (1): washing the mixed solution with water to obtain a first treated solution in which the water-soluble organic solvent concentration is reduced to 0.01 wt % or less, step (2): treating the first treated solution with activated carbon to obtain a second treated solution in which the organic contaminant concentration is reduced to 20 ppb or less, step (3): treating the second treated solution with activated alumina to obtain a third treated solution in which the fluoride ion contaminant is reduced to 10 ppb or less, and step (4): treating the third treated solution with a particle removing filter to obtain a fluorine-based solvent in which the number of particles of 0.1 μm or more is 10 particles/mL or less.

### TECHNICAL FIELD

The present invention relates to a purification process of a mixed solution containing a fluorine-based solvent such as hydrofluorocarbon ether (HFE).

### BACKGROUND

Fluorine-based solvents are used to clean workpieces such as electronic components or semiconductor wafers. Generally while cleaning the workpiece, it is preferred to perform in-line purification of the used cleaning solution. The in-line purification typically consists of using a distillation regenerator, a particle removing filter or the like. For example, Kokai (Japanese Unexamined Patent Publication) No. 2003-47802) and Kokai No. 2001-129302 each describes a distillation regenerator for a fluorine-based solvent. However, with recent progress of fine or high-precision fabrication of components, the following problems are brought about in generating cleaning solution via distillation.

First, a sufficient purity level of the solution is difficult to obtain with the distiller sizes typically used in a normal cleaning apparatus. It is particularly difficult to separate a mixed solution of solvents when two of the solvents have boiling points close to each other.

Second, the particle number in the solution is difficult to reduce to a desired or necessary level by a particle removing filter in a typical cleaning apparatus.

Third, since fluorine-based solvent such as hydrofluorocarbon ether (HFE) is regenerated by distillation, heat is applied to HFE and the amount of fluoride ion in the solution increases.

Fourth, in the case of regenerating the solvent in a large amount, large equipment is necessary and a long regeneration time is required.

Fifth, in the case where a solution having a desired or necessary purity is not obtained, fresh or new solution is typically added or the old solution is replaced. This typically involves, a large amount of liquid.

### SUMMARY

An objective of the present invention is to provide a purification process where a fluorine-based solvent such as hydrofluorocarbon ether (HFE) can be obtained at a high purity by using relatively small equipment and without using a distillation apparatus.

The present invention includes the following embodiments.

(i) A purification process of a mixed solution containing a fluorine-based solvent, which is a process for purifying a fluorine-based solvent from a mixed solution containing a fluorine-based solvent such as hydrofluorocarbon ether (HFE) and/or hydrofluorocarbon (HFC), a water-soluble organic solvent contaminant, an organic contaminant and an ion contaminant, the process comprising:
step (1): washing the mixed solution with water to obtain a first treated solution in which the water-soluble organic solvent contaminant concentration is reduced to 0.01 weight % (wt %) or less,
step (2): treating the first treated solution with activated carbon to obtain a second treated solution in which the organic contaminant concentration is reduced to 20 parts per billion (ppb) or less,
step (3): treating the second treated solution with activated alumina to obtain a third treated solution in which the fluoride ion contaminant being reduced to 10 ppb or less, and
step (4): treating the third treated solution with a particle removing filter to obtain a fluorine-based solvent in which the number of particles having a size of 0.1 μm or more is 10 particles/mL or less.

(ii) A purification process of a mixed solution containing a fluorine-based solvent which is a process for purifying a fluorine-based solvent from a mixed solution containing a fluorine-based solvent such as hydrofluorocarbon ether (HFE) and/or hydrofluorocarbon (HFC), a water-soluble organic solvent contaminant, an organic contaminant and an ion contaminant, the process comprising:
step (1): washing the mixed solution with water to obtain a first treated solution in which the water-soluble organic solvent contaminant concentration is reduced to 0.01 wt % or less,
step (2): treating the first treated solution with activated alumina to obtain a second treated solution in which the fluoride ion contaminant is reduced to 10 ppb or less,
step (3): treating the second treated solution with activated carbon to obtain a third treated solution in which the organic contaminant concentration is reduced to 20 ppb or less, and
step (4): treating the third treated solution with a particle removing filter to obtain a fluorine-based solvent in which the number of particles having a size of 0.1 μm or more is 10 particles/mL or less.

(iii) The purification process of a solution containing a fluorine-based solvent as described in (i) or (ii) above, wherein said fluorine-based solvent is a segregated hydrofluorocarbon ether (HFE), a non-segregated HFE, a hydrofluoropolyether, a hydrofluorocarbon or a hydrochlorofluorocarbon.

(iv) The purification process as described in any one of (i) to (iii) above, wherein in the step (1), using a water-soluble organic solvent removing device comprising a water washing tank and a water eliminator, the mixed solution is washed with water in the water washing tank to remove the water-soluble organic solvent contaminant and then the water is removed from the washed solution by the water eliminator.

(v) The purification process as described in (iv) above, wherein in the step (1), removal of the water-soluble organic solvent contaminant is performed by passing the mixed solution twice or more through the water-soluble organic solvent removing device comprising the water washing tank and the water eliminator.

(vi) The purification process as described in any one of (i) to (v) above, wherein the mixed solution is a used cleaning solution spent once or more for cleaning and the used cleaning solution is regenerated by the purification process.

(vii) The purification process as described in (vi) above, wherein the cleaning solution is a cleaning solution for precision cleaning of electric/electronic components or a cleaning solution for cleaning a semiconductor wafer.

(viii) A purification apparatus, which is a solution purifying apparatus used for the purification process described in any one of (i) to (vii) above, the apparatus comprising
a water-soluble organic solvent removing device for performing the step (1),
an activated carbon filter for performing the step (2),
an activated alumina filter for performing the step (3), and
a particle removing filter for performing the step (4).

(ix) A cleaning apparatus for precision cleaning of electric/electronic components or a cleaning apparatus for cleaning a semiconductor wafer, comprising the purification apparatus described in (viii) above together with a cleaning apparatus for cleaning an electric/electronic component or a semiconductor wafer.

(x) The purification process of a solution containing a fluorine-based solvent described in (iii) above where the fluorine-based solvent is C₄F₉OCH₃ with 0.1 to 10% w/w isopropyl alcohol.

In the present invention, the above-described steps are combined, whereby a high-purity fluorine-based solvent such as hydrofluorocarbon ether can be obtained using small equipment within a short time. Also, regeneration by distillation is not used and therefore, an ion contaminant is not produced during the regeneration process.

Heretofore, it has been difficult to purify used cleaning solution to obtain a sufficiently high-purity fluorine-based solvent for use in the cleaning of semiconductor components, but in the present invention, a fluorine-based solvent applicable to this usage can be obtained. High-purity fluorine-based solvent in this specification means that the solvent meets the following criteria:

the water-soluble organic solvent contamination concentration is 10 ppb or less,

the organic contamination concentration in a fluorine-based solvent is 20 ppb or less,

the number of particles having a size of 0.1 μm or more in a fluorine-based solvent is 10 particles/mL or less.

### BRIEF DESCRIPTION OF THE DRAWINGS

FIG. 1A schematic view of a purification apparatus usable in the present invention.

### DETAILED DESCRIPTION OF THE PREFERRED EMBODIMENTS

The present invention is described below by referring to suitable embodiments. However, it can be easily understood by one skilled in the art that the present invention is not limited to these embodiments. In the following, a case of purifying and regenerating a contaminated fluorine-based solvent such as HFE-containing solution (cleaning solution) by the present invention is described.

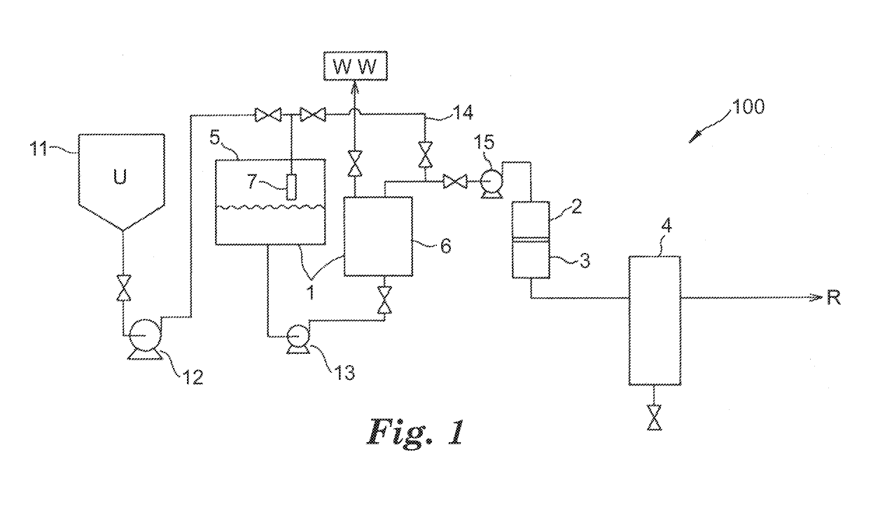

FIG. 1 shows a schematic view of a purification apparatus usable in the present invention. The purification apparatus 100 comprises, as main constituent devices, a water-soluble organic solvent removing device 1, an activated carbon filter 2, an activated alumina filter 3 and a particle removing filter (particulate filter) 4. The activated carbon filter 2 and the activated alumina filter 3 may be in separate columns but, as shown in FIG. 1, these filters may be combined in the same column. Additionally, the activated carbon filter and the activated alumina filter order may be switched (i.e. the activated alumina filter may be before the activated carbon filter) in keeping with the spirit of this invention. Also, the purification apparatus 100 may comprise, if desired, an auxiliary device such as a mixed solution (used cleaning solution) feed tank 11, a feed pump 12, a circulation pump 13, a circulation line 14 and a solution delivery pump 15.

Referring to FIG. 1, the water-soluble organic solvent removing device 1 comprises a water washing tank 5 and a water eliminator 6. A used cleaning solution (U) in the mixed solution (used cleaning solution) feed tank 11 is introduced into the water washing tank 5 by the feed pump 12. The water washing tank 5 is previously filled with a certain amount of water. The used cleaning solution (U) introduced into the water washing tank 5 is introduced into the water as mist or relatively small liquid droplets by a dispersion means such as a sprayer 7. When introduced in this way, the surface area of the used cleaning solution and in turn the contact area with water are increased, so that the water-soluble organic solvent contaminants can be efficiently removed. The water-soluble organic solvent contaminants contained in the used cleaning solution (U) dissolves in the water and the fluorine-based solvent (HFE) is separated as a separate phase from the water. More specifically, in this water washing step, the fluorine-based solvent and the water-soluble organic solvent contaminants are separated based on the difference between the low solubility of the fluorine-based solvent in water and the high solubility of the water-soluble organic solvent contaminants in water. Accordingly, the fluorine-based solvent to be purified is preferably water-insoluble. Even if the fluorine-based solvent is water-soluble, it can be purified by the process of this invention. However, the fluorine-based solvent must be incompatible with water and less soluble in water than the water-soluble organic solvent contaminents. Only a portion of the fluorine-based solvent that is not dissolved in the water can be purified. The fluorine-based solvent dissolved in the water is not recovered because of the difficulty in extracting dissolved fluorine-based solvent from the water by the process of the invention. Therefore, the larger difference in solubility of the fluorine-based solvent in water and water-soluble organic solvent in water, the easier to extract the water soluble organic contaminants from the fluorine-based solvent. Examples of the water-soluble organic solvent contaminants include: water-soluble alcohols such as methanol, ethanol and isopropanol, and short carbon number ketones such as acetone. The separated fluorine-based solvent preferably contains only a trace (0.01 wt % or less) amount of the water-soluble organic solvent contaminant and a trace (1 ppm or less, preferably 30 ppb or less) amount of ionic component. However, the separated fluorine-based solvent is usually accompanied by a small amount of free water. Therefore, the fluorine-based solvent is further treated by a water eliminator 6 and separated into a fluoroine-based solvent containing solution (HFE Liq. 1) and a water-soluble organic solvent contaminant-containing waste water (WW). As for the water eliminator 6, for example, an oil-water separator such as the Eutec filter produced by Asahi Kasei (Tokyo, Japan) can be used. At this stage, if the concentration of water-soluble organic solvent contaminant in the fluorine-based solvent containing solution (HFE Liq. 1) is 0.01 wt % or less and the water content is not more than the saturated water content, the HFE Liq. 1 is delivered to the activated carbon filter 2. In the case where the HFE-containing solution does not have a sufficiently high fluid pressure, fluid pressure necessary for the water eliminator 6 or activated carbon filter 2 and subsequent steps may be obtained by the circulation pump 13 and/or the solution delivery pump 15. If the concentration of water-soluble organic solvent contaminant in the HFE Liq. 1 is 0.01 wt % or more, the HFE Liq. 1 may be returned to the water-soluble organic solvent removing device 1 through the circulation line 14. This time, it has been found that when the treatment is performed twice or more by recirculating the HFE Liq. 1 to the water-soluble organic solvent removing device 1, the water-soluble organic solvent contaminant concentration can be easily reduced to the concentration specified above even by using a smaller water washing tank 5. Also, a similar effect can be obtained by connecting two or more water-soluble organic solvent removing devices 1 in series instead of circulating the HFE Liq. 1 solution.

In the case of circulating the HFE Liq. 1 to the same water-soluble organic solvent removing device 1 or using two water-soluble organic solvent removing devices 1 in series, assuming that the volume ratio of HFE Liq. 1 and water is 1:1, the size of one water washing tank 5 is preferably 6 liters or more, that is, a residence time of 3 minutes or more, per feed of 1 liter/min.

Incidentally, the water-soluble organic solvent contaminant concentration in the HFE Liq. 1 can be measured by gas chromatography (GC).

As described above, a fluorine-based solvent containing solution (HFE Liq. 1) in which the concentration of the water-soluble organic solvent contaminant is reduced to a concentration of about 0.01 wt % or less is obtained as a first treated solution. This first treated solution is delivered to the activated carbon filter 2. The activated carbon filter 2 removes the organic contaminant. Since the water-soluble organic solvent contaminant is mostly removed by the water washing in the water-soluble organic solvent removing device 1 before passing through the activated carbon filter 2, the load for the activated carbon filter 2 is reduced. Examples of the organic contaminant include: hydrocarbons, esters, and silicones. The kind of the activated carbon in the activated carbon filter 2 can be appropriately selected according to the accompanying organic contaminant component. A granular activated carbon having a particle size of 1 to 2 mm is used in Examples, but a powder activated carbon or a fibrous activated carbon may also be used. A powder activated carbon has a possibility of dusting and needs to be used carefully. Examples of useful commercially available activated carbon include Kuraray Coal, activated carbon for liquid phase, produced by Kuraray Chemical Co., Ltd. (Osaka, Japan); Shirosagi produced by Japan EnviroChemicals, Ltd. (Osaka, Japan); and Calgon and Diahope produced by Calgon Mitsubishi Chemical Corp (Tokyo, Japan). The activated carbon may be packed in an appropriate column such as cylindrical column for use.

The size of the activated carbon filter 2 is appropriately determined according to the treating rate and the concentration of organic contaminant in the fluorine-based solvent containing solution (HFE Liq. 1). In the case of treating an HFE-containing solution containing several hundreds of ppb of an organic contaminant, the organic contaminant concentration can be reduced to 10 ppb or less by an activated carbon filter of 10 liters, that is, a residence time of 10 minutes per feed at 1 liter/min. Incidentally, the organic contaminant concentration can be measured by a Fourier transformation infrared spectrometer (FT-IR).

The fluorine-based solvent containing solution (HFE Liq. 1) solution passed through the activated carbon filter 2 is obtained as a second treated solution, and the second treated solution is delivered to the activated alumina filter 3. Since most of the ionic components in the fluorine-based solvent are removed by water washing, the load on the activated alumina is lowered. The activated alumina filter 3 removes the ion contaminant in the fluorine-based solvent containing solution. The size of the activated alumina is not particularly limited, but a granular alumina having a particle diameter of 1 to 2 mm or more is easy to use. A powdered alumina has a possibility of dusting and needs to be used carefully. As for the specific product, KH Series produced by Sumitomo Chemical Co. Ltd. (Tokyo, Japan), and activated alumina produced by Showa Denko K.K. (Tokyo, Japan) can be used. The size of the activated alumina filter 3 is appropriately determined according to the treating rate and the concentration of ion contaminant in the fluorine-based solvent. In the case of treating an HFE-containing solution containing several tens of ppb of an ion contaminant, the ion contaminant concentration can be reduced to about 1 ppb or less by an activated alumina filter of 5 liters, that is, a residence time of 5 minutes per feed at 1 liter/min. Incidentally, the fluoride ion concentration can be measured by using an ion meter or a fluoride ion electrode.

The fluorine-based solvent containing solution passed through the activated alumina filter 3 is obtained as a third treated solution, and the third treated solution is delivered to the particle removing filter 4. In the particle removing filter 4, the fluorine-based solvent containing solution is treated until the number of particles of about 0.1 μm or more are reduced to 10 particles/mL or less, whereby a regenerated cleaning solution (R) can be finally obtained. The particle removing filter 4 may be a filter using a polymer membrane as the filter element and, for example, a polytetrafluoroethylene (PTFE) membrane and a tetrafluoroethylene-perfluoroalkyl vinyl ether copolymer (PFA) housing filter such as the UltiKleen filter (for 0.05 to 0.2 μm) produced by Pall Corp. (East Hills, N.Y., USA). Other filters may be used if the filter is capable of removing particles of appropriate size. However, in the case of using a filter made of polypropylene (PP) or polyethylene (PE), contamination may be generated from the filter depending on the kind of the polymer or vendor. Therefore, a filter comprising polytetrafluoroethylene (PTFE) and a tetafluoroethylene-perfluoroalkyl vinyl ether copolymer (PFA) is preferably used.

The size of the particle removing filter 4 is generally about 4 inches (101.6 mm), 10 inches (254 mm), 20 inches (508 mm) or 30 inches (762 mm) in length, but may be appropriately selected according to the desired flow rate. A disposable-type filter may also be used. The number of particles in the solution can be measured by an in-liquid particle counter.

For the removal of water in the first treated solution, in addition to the Eutec filter produced by Asahi Kasei described above, molecular sieve and ion exchange resin produced by Union Showa K.K. (Tokyo, Japan) are also effective. The molecular sieve and ion exchange resins are preferably selected and used depending on the required characteristics. The above-described activated carbon filter or activated alumina filter also has an ability of removing water, but in order to reduce the load, an additional water eliminator 6 is preferably used.

As for the construction material of the piping or packings for connecting the above-described devices, in order to avoid generation of contamination, a stainless steel (SUS), a polytetrafluoroethylene (PTFE) or a tetrafluoroethylene-perfluoroalkyl vinyl ether copolymer (PFA) is preferably used. Also, a construction material which is not a fluorine-based resin may be used as long as substantial elution of a plasticizer does not occur (for example, Ethylene Propylene Diene Monomer (EPDM) not using a plasticizer, and Arcury produced by Nippon Valqua Industries, Ltd.) (Tokyo, Japan).

In the foregoing pages, the process of the present invention is described based on the following order, a water-soluble organic solvent contaminant removing step using a water-soluble organic solvent removing device 1 (step (1)), an organic contaminant removing step using an activated carbon filter 2 (step (2)), an ion contaminant removing step using an activated alumina filter 3 (step (3)), and a particle removing step using a particle removing filter (particulate filter) 4 (step (4)). Step (1) should be performed in advance of steps (2) and (3) to increase the lifetime of the activated carbon or activated alumina columns. The water-soluble organic solvent contaminant, if not removed, can adsorb onto the activated carbon or alumina in steps (2) and (3) and thereby potentially decreasing the column lifetime. The order of steps (2) and (3) may be switched without any known concerns. Furthermore, step (4) should be performed after steps (2) and (3), to remove any potential particulates that may be introduced during steps (2) and (3).

The purification process of the present invention may be performed either in a separate stand-alone purification apparatus or in an in-line purification apparatus integrated with a cleaning apparatus. Incorporation as a part of the cleaning apparatus is preferred because the purification apparatus can be downsized.

In the precision cleaning of electric/electronic components or in the cleaning of a semiconductor wafer, since fine wiring or the like is arranged, for example, trace organic impurity or ion contaminant remaining in the cleaning solution causes a malfunction such as conductor failure. Accordingly, the cleaning solution regenerated by the process of the present invention capable of satisfactorily removing these contaminants can be advantageously used in such cleaning. Also, an in-line arrangement of the cleaning solution regeneration process in a cleaning apparatus can be achieved by combining the apparatus for practicing the present invention with the cleaning apparatus, so that a high-purity fluorine-based solvent can be always provided to the cleaning apparatus.

The fluorine-based solvent used in this invention includes a segregated hydrofluorocarbon ether (HFE), a non-segregated HFE, a hydrofluoropolyether, a hydrofluorocarbon or a hydrochlorofluorocarbon. Incidentally, in a segregated HFE, segments of HFE such as alkyl or alkylene segment linked via ether oxygen are either perfluorinated (for example, perfluorocarbon) or not fluorinated (for example, hydrocarbon), and thus they are not partially fluorinated. In a non-segregated HFE, at least one of segments linked via ether oxygen is not perfluorinated, not non-fluorinated, but partially fluorinated (i.e., containing a mixture of fluorine atoms and hydrogen atoms). The fluorine-based solvent used in the purification process of this invention includes 3M<Novec> 7100 containing 0.1 to 10 wt % of isopropanol. Further, the fluorine-based solvent used in the purification process of this invention may include methanol, ethanol, propanol or isopropanol in addition to a fluorine-based solvent.

Specifically, a fluorine-based solvent useful in the present invention includes the following solvents.

### Segregated HFE

c-C₆F₁₁CF₂OC₂H₅,
c-C₆F₁₁CF₂OCH₃, 4-CF₃-c-C₆F₁₀CF₂OCH₃,

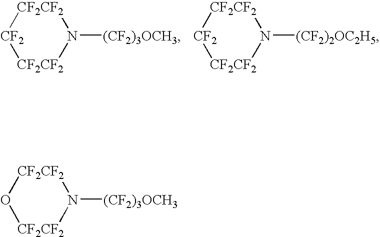

CH₃OCF₂-c-C₆F₁₀CF₂OCH₃, C₄F₉OC₂H₅,
C₄F₉OCH₃, c-C₆F₁₁OCH₃, (CF₃)₂CFCF₂OCH₃, (CF₃)₂CFCF₂OC₂H₅, C₈F₁₇OCH₃, C₂F₅CF(OCH₃)CF(CF₃)₂, CF₃CF(OCH₃)CF(CF₃)₂, C₅F₁₁OCH₃, C₅F₁₁OC₂H₅, C₃F₇OCH₃, non-segregated HFE, C₈F₁₇—O—C₂F₄H, C₇F₁₅—O—C₂F₄H, C₆F₁₃—O—C₂F₄—O—CF₂H, C₄F₉—O—C₂F₄H, HCF₂CF₂—O—CF₂CF₂—O—CF₂CF₂H, C₄F₉—O—(CF₂)₅H, C₅F₁₁—O—(CF₂)₅H, C₈F₁₇—O—(CF₂)₅H, C₄F₉—O—CF₂C(CF₃)₂CF₂H,

### H(CF₂)₄—O—(CF₂)₄H, Cl(CF₂)₄—O—(CF₂)₄H, C₆F₁₃—O—C₂F₄H,

### C₄F₉—O—(CF₂)₄—O—(CF₂)₃H,

(C₂F₅)₂CFCF₂—O—C₂F₄H, c-C₆F₁₁CF₂—O—C₂F₄H, C₄F₉—O—C₂F₄—O—C₃F₆H,
C₆F₁₃—O—C₄F₈H, C₆F₁₃—O—C₃F₆H, C₅F₁₁—O—(CF₂)₄H, C₄F₉—O—C₃F₆H,

### C₈F₁₇OCF₂OC₃F₆H, HC₃F₆OC₃F₆H,

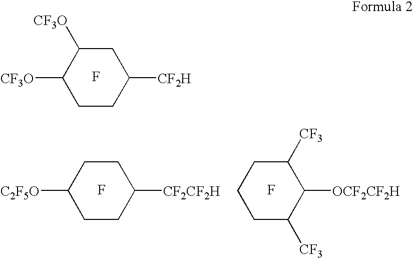

C₅F₁₁OCF₂C(CF₃)₂CF₂H, (C₄F₉O)₂CFCF₂H, CF₃O(CF₂)₉H, and (iso-C₃F₇)₂CFOC₂F₄H.

Further, it includes CF₃CFHCFHC₂F₅, CF₃CH₂CF₂CH₃, CF₃CF₂CHCl₂, CClF₂CF₂CHClF, 2-chloro-1,1,12-trifluoromethyl ethyl ether, tetrafluoroethyl methyl ether, and tetrafluoroethyl ethyl ether.

### EXAMPLES

The present invention is described below by referring to Examples, but the present invention is not limited to these Examples. In Examples, the following devices, measuring methods and materials were used.

### Device:

Water washing tank 5: a drum volume of 60 liters

Water separator 6: Eutec Filter TH Series produced by Asahi Kasei

Activated carbon filter 2: a stainless steel (SUS)-made cylindrical column having packed therein 2,600 cm³ of WH2C (activated carbon having a particle size of 8 to 32 mesh and a specific surface area of 1,200 m²/g) produced by Takeda Chemical Industries, Ltd. (Osaka, Japan)

Activated alumina filter 3: a stainless steel (SUS)-made cylindrical column having packed therein 1,300 cm³ of KHO-12 (alumina having a particle diameter of 1 to 2 mm and a specific surface area of 140 to 190 m²/g) produced by Sumitomo Chemical Co., Ltd. (Tokyo, Japan)

Particle removing filter 4: UltiKleen filters (for 0.05 μm and for 0.1 μm) produced by Pall Corp (East Hills, N.Y., USA). Emflon and IonKleen-SL (both from Pall Corp.) are also used in Example 4.

### Measuring Method:

### Measuring Method of Alcohol Concentration

The alcohol concentration in the fluorine-based solvent was measured by using Gas Chromatograph HP6890 manufactured by Hewlett Packard. Incidentally, in order to convert the concentration obtained by the gas chromatograph into a weight concentration, a calibration curve was prepared using a mixed solution of fluorine-based solvent and alcohol. The alcohol was the same as that added in the solution to be purified. In the Examples, only data on the alcohol concentration in the fluorine-based solvent are shown, but in practice, the alcohol concentration in the separated water phase was also measured in the same manner.

### Measuring Method of Organic Contaminant

A certain amount of the sample was put in a clean beaker and the solvent component was evaporated by using an oven at 50° C. The weight of the residue was measured and designated as a residue weight. This residue was dissolved in a certain amount of carbon tetrachloride (purity 99.5% or more) from Wako Pure Chemical Industries, Ltd., (Osaka, Japan), and the resulting solution was analyzed by a Fourier transformation infrared spectrometer (FT-IR) 1600 Series manufactured by Perkin Elmer (Wellesley, Mass.). Thereafter, the amounts of extracted hydrocarbon, ester and silicone each were quantitatively converted using a calibration curve prepared from squalane (purity 98% or more), bis(2-ethylhexyl) phthalate (DOP) (purity 97% or more), both from Wako Pure Chemical Industries, Ltd. (Chuo-ku, Osaka) and silicone oil KF-96 from Shin-Etsu Chemical Co., Ltd. (Tokyo, Japan).

### Measuring Method of Concentration of Various Ions (Ion Chromatography)

The sample was put in a clean plastic bottle made of high-density polyethylene (HDPE) and after adding ultrapure water (purified by Milli-Q Ultrapure Water Purification System from Millipore Japan (Tokyo, Japan)) of the same weight, the plastic bottle was shaken using a shaker for 2 hours, thereby extracting the ions in the fluorine-based solvent to the aqueous layer. Subsequently, the aqueous layer (upper layer) was injected into an Ion Chromatograph DX320 manufactured by Dionex (Sunnyvale, Calif.) to determine the amount of ion in the solution. To compensate for the ion concentration inherently present in the ultrapure water used in this measurement, ion concentration of ultrapure water is subtracted from the ion concentration of the sample. Detection limit of ion chromatography is about 0.01 ppb.

### pH Measuring Method

The sample was put in a clean plastic bottle and after adding ultrapure water of the same weight, the plastic bottle was shaken using a shaker for 2 hours. Subsequently, the pH of the aqueous layer (upper layer) was measured. For the measurement, Model 920A pH Meter manufactured by Orion Research Inc. (Boston, Mass., USA) was used.

### Measuring Method of Particle Number in Solution

The solution was transferred to a clean vessel and the particle number in the solution was measured using an in-liquid particle counter KS-40A manufactured by Rion Co., Ltd (Tokyo, Japan). The measured particle number was converted into the particle number per mL.

### Measuring Method of Water Volume

The water volume in the sample was measured using a Karl-Fischer type water meter CA-21 manufactured by Mitsubishi Chemical Corp (Tokyo, Japan).

### Materials Used

Hydrofluorocarbon ether obtained under the trade name “3M Novec™ HFE-7100” from Sumitomo 3M, (Tokyo, Japan)

Hydrofluorocarbon ether obtained under the trade name “AE-3000” from Asahi Glass Company, Ltd.: HFE-347 pc-f (CHF₂CF₂OCH₂CF₃)

IPA: isopropyl alcohol (purity 99.5% or more) from Wako Pure Chemical Industries, Ltd

EtOH: ethanol (purity 99.5% or more) from Wako Pure Chemical Industries, Ltd

Tests for confirming the performance of each device were performed.

### Example 1

### Water-Soluble Organic Solvent Contaminant Removing Step

### Test 1:

A simulated contaminated fluorine-based cleaning solution was made using 3M Novec™ 7100 and various concentrations of IPA. This simulated contaminated cleaning solution was treated using a water-soluble organic solvent removing device comprising a water washing tank and water eliminator to remove the IPA. The IPA concentration after treatment is shown in Table 1 below. The IPA concentration after treatment was measured using a gas chromatograph as described in “Measuring Method of Alcohol Concentration” above.

TABLE 1

| Solution Composition (wt %) | | | |
|---|---|---|---|
| Novec ™ | | Treatment | IPA Concentration after |
| HFE-7100 | IPA | Time | Treatment (wt %) |
| 95 | 5 | 10 min | 0.093 |
| 90 | 10 | 10 min | 0.105 |
| 80 | 20 | 10 min | 0.231 |
| 60 | 40 | 10 min | 0.463 |

### Test 2:

Next, the treated solutions to various IPA concentration was again passed through the water washing tank and water eliminator to remove IPA with different treatment times. The IPA concentration after this treatment was measured using a gas chromatograph. The results for this second treatment are shown in Table 2 below.

TABLE 2

| Solution Composition (wt %) | | | | |
|---|---|---|---|---|
| Novec ™ | | Treatment | | IPA Concentration after |
| HFE-7100 | IPA | Time | | Treatment (wt %) |
| 99.80 | 0.20 | 5 to 10 | sec | N.D. |
| 99.80 | 0.20 | 1 | min | N.D. |
| 99.66 | 0.34 | 5 to 10 | sec | N.D. |
| 99.66 | 0.34 | 30 | sec | N.D. |
| 99.37 | 0.63 | 10 | sec | 0.036 |
| 99.37 | 0.63 | 1 | min | 0.033 |
| 99.37 | 0.63 | 3 | min | 0.029 |
| 99.37 | 0.63 | 5.5 | min | N.D. |
| 99.37 | 0.63 | 10 | min | N.D. |

N.D. means IPA was not detected (detection limit: 0.001 wt %)

### Test 3:

Another simulated contaminated fluorine-based cleaning solution was made 3M Novec™ 7100 and 5 wt % IPA. This simulated contaminated fluorine-based cleaning solution was passed through the water washing tank and water eliminator to remove IPA. Various treatment times were used and the resulting IPA concentration was measured. The results are shown in Table 3 below.

TABLE 3

| Solution Composition (wt %) | | | | |
|---|---|---|---|---|
| Novec ™ | | Treatment | | IPA Concentration after |
| HFE-7100 | IPA | Time | | Treatment (wt %) |
| 95 | 5 | 10 | sec | 0.168 |
| 95 | 5 | 1 | min | 0.182 |
| 95 | 5 | 3 | min | 0.121 |
| 95 | 5 | 5 | min | 0.110 |
| 95 | 5 | 10 | min | 0.088 |

### Test 4:

Using yet another simulated contaminated fluorine-based cleaning solution comprising 3M Novec™ 7100 and 10 wt % IPA, the simulated contaminated fluorine-based cleaning solution was passed through the water washing tank and water eliminator to remove IPA. Various treatment times and numbers of treatments were used. The resulting IPA concentration was measured and the results are shown in Table 4.

TABLE 4

| Solution Composition | | | | |
|---|---|---|---|---|
| (wt %) | | | | Concentration after |
| Novec | | Treatment Cycle and Time | | Treatment |
| HFE-7100 | IPA | Step 1 | Step 2 | IPA (wt %) |
| 90 | 10 | 5 to 10 sec | — | 0.126 |
| 90 | 10 | 10 min | — | 0.109 |
| 90 | 10 | 10 min | 5 to 10 sec | 0.045 |
| 90 | 10 | 10 min | 1 min | N.D. |

N.D. means that IPA was not detected

### Example 2

### Organic Contaminant Removing Step Using Activated Carbon Filter

### Test 1:

3M Novec™ 7100 contaminated with hydrocarbon and ester was used in this test. Activated carbon filters used for the removal of organic contaminant were constructed with two different carbon sources. Kuraray Coal, activated carbon for liquid phase, produced by Kuraray Chemical Co., Ltd. (Osaka, Japan), was column No 1. in Table 5 and Shirosagi produced by Japan EnviroChemicals, Ltd. (Osaka, Japan) is column No. 2 in Table 5. The concentration of organic contaminant (hydrocarbons and esters) was measured by the “Measuring Method of Organic Contaminant” above. The results are shown in Table 5 below.

TABLE 5

| | | Hydrocarbon (ppb) | | Ester (ppb) | |
|---|---|---|---|---|---|
| | Contact | Before | After | Before | After |
| No. | Time | Treatment | Treatment | Treatment | Treatment |
| 1 | 5 min | 184.6 | 3.5 | 13.3 | N.D. |
| 2 | 5 min | 184.6 | 1.8 | 13.3 | N.D. |

Note)
N.D. means that ester was not detected.

### Test 2:

Using No. 2 (Shirosagi), a solution of hydrofluorocarbon ether was extracted through the column to remove organic contaminants. A predetermined amount of activated carbon was put into a clean column. 3M Novec™ 7100 was contaminated to stimulate used condition. The stimulated contaminated 3M Novec™ 7100 solution was then poured into the column and exposed to the activated carbon for 5 minutes. The impact of the volume to volume (V/V) ratio of solution added versus the amount of activated carbon was varied. The results are shown in Table 6 below.

TABLE 6

| | Solution/ | Hydrocarbon (ppb) | | Ester (ppb) | |
|---|---|---|---|---|---|
| | Activated Carbon | Before | After | Before | After |
| Trial | (V/V) | Treatment | Treatment | Treatment | Treatment |
| 1 | 13 | 85154 | 6.2 | 159849 | 9.1 |
| 2 | 39 | 85154 | 10.3 | 159849 | 7.4 |
| 3 | 65 | 85154 | 2.6 | 159849 | 4.3 |
| 4 | 91 | 85154 | 3.3 | 159849 | 3.0 |
| 5 | 130 | 85154 | 2.4 | 159849 | 3.3 |
| 6 | 143 | 85154 | 1.6 | 159849 | 3.3 |

### Example 3

### Ion Contaminant Removing Step Using Activated Alumina Filter

Solutions of stimulated contaminated 3M Novec™ 7100 were passed through an activated alumina filter described earlier. Two different trials were performed the first trail the activated alumina had a surface area of 156 m²/g and the second trial had a surface area of 190 m²/g. The ion contaminant concentration was measured by the “Measuring Method of Concentration of Various Ions”. Solutions used for trial 1 and 2 were from different contaminated Novec container, thus they have different F anion contamination level before the test. The results are shown in Table 7 below.

TABLE 7

| | | | F Anion (ppb) | |
|---|---|---|---|---|
| | | | Before | After |
| Trial | Column Surface Area | Contact Time | Treatment | Treatment |
| 1 | 156 m²/g | 10 min. | 1121 | 8.15 |
| 2 | 190 m²/g | 10 min. | 3193 | N.D. |

Note)
N.D. means that the anion was not detected (detection limit of 0.01 ppb).

### Example 4

### Particle Removing Step Using Particle Filter

### Test 1:

To ensure that the particle filters do not introduce additional contaminants to the fluorine-based solvent cleaning solution, a solution of HFE was passed through various particle filters and the organic contaminants were analyzed using a Fourier transformation infrared spectrometer (FT-IR) by the “Measuring Method of Organic Contaminant”. Each filter was washed with 3M Novec™ 7100 before filtering the sample for organic contaminant analysis. The HFE solution not passed through any filter was also tested and the amount of increase in organic contaminant due to the particle filters is reported in Table 8 below. Two trials were performed on each filter. Also shown is Table 8 are the materials for each filter type.

TABLE 8

| | | | | | | Organic Contaminant Increased in HFE | | |
|---|---|---|---|---|---|---|---|---|
| | | | Material | | | HC as Squalane | Ester as DOP | Silicone |
| Trial | Filter Name | Type Code | Membrane | Housing | Seal | (μg/lg-HFE) | (μg/lg-HFE) | (μg/lg-HFE) |
| 1 | Emflon | DFAIFTESNP64M | PTFE | PP | hot seal | 25.65 | 11.14 | 0.00 |
| 1 | UltiKleen | LDFNO3UFD7E2 | PTFE | PFA | hot seal | 1.04 | 0.07 | 0.00 |
| 1 | IonKleen-SL | DFAISRPESW44 | PE | PP | hot seal | 13.02 | 1.28 | 0.00 |
| 2 | Emflon | DFAIFTESNP64M | PTFE | PP | hot seal | 23.61 | 9.76 | 0.00 |
| 2 | UltiKleen | LDFNO3UFD7E2 | PTFE | PFA | hot seal | 0.10 | 0.06 | 0.00 |
| 2 | IonKleen-SL | DFAISRPESW44 | PE | PP | hot seal | 9.75 | 1.11 | 0.00 |

N.D. means not detected.
Contaminant concentration of 3M Novec ™ 7100 before treatment (not passed through filter): 0.15 μg/lg-HFE of HC as Squalane, 0.07 μg/lg-HFE of Ester as DOP and no Silicone detected.

### Test 2:

Subsequently, a test of removing particles in Novec™ 7100 produced by 3M was performed using the UltiKleen filter. The HFE solution was divided into 9 aliquots, one aliquot was not filtered and the 8 remaining aliquots were filtered through the UltiKleen filter. Each aliquot was then measured by the “Measuring Method of Particle Number in Solution”. The results are shown in Table 9 below.

TABLE 9

| | Particle Number in Solution (particle/mL) | | | | |
|---|---|---|---|---|---|
| | Converted Value | | | | |
| Sample | >0.1 μm | >0.15 μm | >0.2 μm | >0.3 μm | >0.5 μm |
| 1 | 5.0 | 3.3 | 2.5 | 1.4 | 0.9 |
| 2 | 3.4 | 2.3 | 2.0 | 1.3 | 0.7 |
| 3 | 9.0 | 5.4 | 3.2 | 1.9 | 1.5 |
| 4 | 4.9 | 2.9 | 2.3 | 1.3 | 0.7 |
| 5 | 4.6 | 2.0 | 1.0 | 0.4 | 0.3 |
| 6 | 2.7 | 1.2 | 0.8 | 0.4 | 0.2 |
| 7 | 2.5 | 1.0 | 0.5 | 0.2 | 0.1 |
| 8 | 2.4 | 1.3 | 0.8 | 0.5 | 0.2 |
| Not filtered | not | not | not | 4611 | 3344 |
| | measured | measured | measured | | |

Furthermore, HFE solutions derived from 3 lots of 3M Novec™ 7100 solution treated as described above was also measured by the “Measuring Method of Organic Contaminant”. The results are shown in Table 10 below.

TABLE 10

| | Organic Contaminant (ppb) | | |
|---|---|---|---|
| Liquid | HC | Ester | Silicone |
| HFE-7100 | 5.6 | 3.8 | N.D. |
| HFE-7100 | 4.2 | 2.8 | N.D. |
| HFE-7100 | 1.1 | 2.7 | N.D. |

Note)
N.D. means that silicone was not detected.

It is seen from comparing the results in Table 10 and not filtered HFE contaminant level in test 1 of Example 4 that the particles can be removed without incurring organic contamination by an organic residue from the filter.

### Example 5

A stimulate contaminated HFE cleaning solution containing about 5 wt % of isopropyl alcohol (IPA) was regenerated using the Device described above at the beginning of this Example section. The HFE used was Novec™ 7100 produced by 3M.

The solution in the water washing tank had a composition of water: (HFE/IPA)=1:1 (by mass) and the treatment was performed twice by batch processing. The first treatment time was 5 minutes followed by additional 1 minute wash after replacing the water with fresh water. The test was repeated 5 times to see process variation. The IPA concentration was measured on each treated solvents by the “Measuring Method of Alcohol Concentration”. On these same samples, the fluoride ion contaminant, water content volume and pH were also measured by the methods described above. The results are shown in Table 11 below.

TABLE 11

| | | | F⁻ Ion | Water |
|---|---|---|---|---|
| | IPA | | Concentration | Concentration |
| Trial | (wt %) | pH | (ppb) | (ppm) |
| Before treatment | 5.741 | 4.45 | 0.59 | 825 |
| 1 | 0.004 | 5.58 | 0.01 | 84 |
| 2 | 0.001 | 5.64 | 0.01 | 97 |
| 3 | 0.004 | 5.67 | 0.01 | 104 |
| 4 | 0.002 | 5.65 | 0.01 | 108 |
| 5 | 0.001 | 5.63 | 0.01 | 97 |

Then, the sample stream of “Trial 3” was passed from the water eliminator to the activated carbon filter, then on to the activated alumina filter and finally through the particle filter. The IPA concentration, organic contaminant and particle number after treatments were measured by the above-described methods. The results are shown in Table 12 below. Contact time in the table means contact time at the column containing the activated carbon filter and the activated aluminum filter.

TABLE 12

| | | | Contact | Contact |
|---|---|---|---|---|
| | | Before | Time of 5 | Time of 10 |
| | | Treatment | Minutes | Minutes |
| Organic contaminant | HC | 943 | 22.8 | 1.6 |
| ppb | ester | 585 | N.D. | N.D. |
| | silicone | N.D. | N.D. | N.D. |
| IPA Concentration | wt % | 0.042 | N.D. | N.D. |
| Particle number in | >0.1 μm | Not | 2.2 | 7.2 |
| solution | | measured | | |
| (particles/mL) | >0.15 μm | Not | 1.0 | 3.3 |
| | | measured | | |
| | >0.2 μm | Not | 0.4 | 2.0 |
| | | measured | | |
| | >0.3 μm | 3086.3 | 0.1 | 1.2 |
| | >0.5 μm | 1632.6 | 0.0 | 0.7 |
| | >1 μm | 418.4 | Not | Not |
| | | | measured | measured |
| | >2 μm | 118.0 | Not | Not |
| | | | measured | measured |
| | >5 μm | 23.7 | Not | Not |
| | | | measured | measured |
| | >10 μm | 8.5 | Not | Not |
| | | | measured | measured |
| Water amount | ppm | 104 | 17 | 23 |
| Anion concentration | F⁻ | 1.24 | 0.09 | 0 |
| in solution (ppb) | CH3COO⁻ | 0 | 0 | 0 |
| | HCOO⁻ | 0.26 | 0.18 | 0.05 |
| | Cl⁻ | 0.22 | 6.30 | 0.48 |
| | NO₂⁻ | 0.34 | 0.14 | 0.06 |
| | NO₃⁻ | 0 | 0 | 0 |
| | Br⁻ | 0 | 0 | 0 |
| | SO₄²⁻ | 0 | 0.41 | 0.23 |
| | COO⁻ | 0 | 0 | 0 |
| | PO₄³⁻ | 0 | 0.22 | 0 |
| Cation concentration | Li⁺ | 0 | 0 | 0 |
| in solution (ppb) | Na⁺ | 0.10 | 0.43 | 0.09 |
| | NH₄⁺ | 0.17 | 0.26 | 0.29 |
| | K⁺ | 0 | 0.26 | 0.06 |
| | Mg⁺ | 0.02 | 0.05 | 0.08 |
| | Ca⁺ | 0.34 | 0.30 | 0.48 |
| | Ni⁺ | 0 | 0 | 0 |

N.D. means Not Detected
“0” anion or cation concentration means that the ion concentration of test sample was the same or fewer than that of ultra-pure water used for measurement.

### Example 6

The test was performed on the HFE-347-pcf (CHF₂CF₂OCH₂CF₃) containing 10 wt % of ethanol. The solution containing fluorine-based solvent and ethanol was washed 5 minutes followed by another 5 minutes wash. Before the 2^{nd} 5 minute wash, the water in the water washing tank was replaced with the clean water. A part of the solution was taken from the tank at the time shown in the table 13 for analysis.

### Conditions:

Solution: HFE-347-pcf containing 10 wt % of ethanol

Condition of Water Washing Tank:
water: HFE/ethanol mixed solution=1:1 (by mass)

Treatment Time:
first step: from 1 to 5 minutes, second step: from 1 to 5 minutes (before the second step, water was replaced with new water)

The ethanol concentration of each sample was measured. The results are shown in Table 13 below.

TABLE 13

| | | |
|---|---|---|
| Water Washing | HFE-347pcf | Ethanol |

| Time (min) | GC area % | GC area % | wt % |
|---|---|---|---|
| Before washing | 72.549 | 27.451 | 9.718 |
| 1 | 98.786 | 1.214 | 0.377 |
| 2 | 99.028 | 0.972 | 0.307 |
| 3 | 99.007 | 0.993 | 0.314 |
| 5 | 99.033 | 0.967 | 0.304 |
| 6 | 99.729 | 0.271 | 0.086 |
| 7 | 99.913 | 0.087 | 0.027 |
| 8 | 99.956 | 0.044 | 0.014 |
| 10 | 100 | N.D. | N.D. |

N.D. means not detected.

Sample 8 stream after washing was passed through the activated carbon filter, through the activated alumina filter and finally through the particle filter. The organic contaminant and particle number after treatments were measured by the above-described methods. The results are shown in Table 14 below.

TABLE 14

| | | Contact Time in Column | | |
|---|---|---|---|---|
| | | Before | | |
| Purity of Solution | | Treatment | 5 Minutes | 10 Minutes |
| organic contaminant | HC | 854.8 | 10.2 | 16.5 |
| (ppb) | ester | 128.8 | 2.0 | 1.2 |
| | silicone | N.D. | N.D. | N.D. |
| Particle number in | >0.1 μm | Not | 1.7 | 2.3 |
| solution | | measured | | |
| (particles/mL) | >0.15 μm | Not | 1.4 | 1.6 |
| | | measured | | |
| | >0.2 μm | Not | 1.1 | 1.4 |
| | | measured | | |
| | >0.3 μm | 4611 | 0.9 | 1 |
| | >0.5 μm | 3344 | 0.7 | 0.6 |
| | >1 μm | 1747 | Not | Not |
| | | | measured | measured |
| | >2 μm | 950 | Not | Not |
| | | | measured | measured |
| | >5 μm | 246 | Not | Not |
| | | | measured | measured |
| | >10 μm | 46 | Not | Not |
| | | | measured | measured |
| Water amount (ppm) | | 792 | 77 | 70 |
| Anion concentration | F⁻ | 0.48 | 0.02 | 0 |
| in solution (ppb) | CH3COO⁻ | 0 | 1.91 | 1.21 |
| | HCOO⁻ | 2.53 | 0 | 0 |
| | Cl⁻ | 6.90 | 4.58 | 3.69 |
| | NO₂⁻ | 0.32 | 0.25 | 0.17 |
| | NO₂⁻ | 0.67 | 0 | 0 |
| | Br⁻ | 0.20 | 0.07 | 0.09 |
| | SO₄²⁻ | 1.01 | 0.49 | 0.43 |
| | COO⁻ | 0 | 0 | 0 |
| | PO₄³⁻ | 0 | 0 | 0.10 |
| Cation concentration | Li⁺ | 0 | 0 | 0 |
| in solution (ppb) | Na⁺ | 3.92 | 2.13 | 0.50 |
| | NH₄⁺ | 0.11 | 0.02 | 0.19 |
| | K⁺ | 1.12 | 0.14 | 0 |
| | Mg⁺ | 0.26 | 0.10 | 0.11 |
| | Ca⁺ | 1.62 | 0 | 0 |
| | Ni⁺ | 0 | 0 | 0 |

Note)
N.D. means that silicone was not detected.
“0” anion or cation concentration means that the ion concentration of test sample was the same or fewer than that of ultra-pure water used for measurement.

1. A purification process of a mixed solution containing a fluorine-based solvent, a water-soluble organic solvent contaminant, an organic contaminant and an ion contaminant, the process comprising:
step (1): washing the mixed solution with water to obtain a first treated solution in which the water-soluble organic contaminant solvent concentration is reduced to 0.01 wt % or less,
step (2): treating said first treated solution with activated carbon to obtain a second treated solution in which the organic contaminant concentration is reduced to 20 ppb or less,
step (3): treating said second treated solution with activated alumina to obtain a third treated solution in which a fluoride ion contaminant is reduced to 10 ppb or less, and
step (4): treating said third treated solution with a particle removing filter to obtain a fluorine-based solvent in which the number of particles having a size of 0.1 μm or more is 10 particles/mL or less.

2. A purification process of a mixed solution containing a fluorine-based solvent, a water-soluble organic solvent contaminant, an organic contaminant, and an ion contaminant, the process comprising:
step (1): washing the mixed solution with water to obtain a first treated solution in which the water-soluble organic solvent contaminant concentration is reduced to 0.01 wt % or less,
step (2): treating said first treated solution with activated alumina to obtain a second treated solution in which a fluoride ion contaminant is reduced to 10 ppb or less,
step (3): treating said second treated solution with activated carbon to obtain a third treated solution in which the organic contaminant concentration is reduced to 20 ppb or less, and
step (4): treating said third treated solution with a particle removing filter to obtain a fluorine-based solvent in which the number of particles having a size of 0.1 μm or more is 10 particles/mL or less.

3. The purification process of a solution containing a fluorine-based solvent of claim 1, wherein said fluorine-based solvent is a segregated hydrofluorocarbon ether (HFE), a non-segregated HFE, a hydrofluoropolyether, a hydrofluorocarbon or a hydrochlorofluorocarbon.

4. The purification process of claim 1, wherein in said step (1), using a water-soluble organic solvent removing device comprising a water washing tank and a water eliminator, said mixed solution is washed with water in said water washing tank to remove the water-soluble organic solvent contaminant and then water is removed from the washed solution by the water eliminator.

5. The purification process of claim 4, wherein in said step (1), removal of the water-soluble organic solvent contaminant is performed by passing the mixed solution twice or more through said water-soluble organic solvent removing device comprising said water washing tank and said water eliminator.

6. The purification process of claim 1, wherein said mixed solution is a used cleaning solution spent once or more for cleaning and the used cleaning solution is regenerated by said purification process.

7. The purification process of claim 6, wherein said cleaning solution is a cleaning solution for precision cleaning of electric/electronic components or a cleaning solution for cleaning a semiconductor wafer.

8. A purification apparatus used for the purification process claim 1, the apparatus comprising
a water-soluble organic solvent removing device for performing said step (1),
an activated carbon filter for performing said step (2),
an activated alumina filter for performing said step (3), and
a particle removing filter for performing said step (4).

9. A cleaning apparatus for precision cleaning of electric/electronic components or a cleaning apparatus for cleaning a semiconductor wafer, comprising the purification apparatus of claim 8 together with a cleaning apparatus for cleaning an electric/electronic component or a semiconductor wafer.

10. The purification process of claim 3 where the fluorine-based solvent is C₄F₉OCH₃ with 0.1 to 10% w/w isopropyl alcohol.

11. The purification process of claim 2, wherein said fluorine-based solvent is a segregated hydrofluorocarbon ether (HFE), a non-segregated HFE, a hydrofluoropolyether, a hydrofluorocarbon or a hydrochlorofluorocarbon.

12. The purification process of claim 2, wherein in said step (1), using a water-soluble organic solvent removing device comprising a water washing tank and a water eliminator, said mixed solution is washed with water in said water washing tank to remove the water-soluble organic solvent contaminant and then water is removed from the washed solution by the water eliminator.

13. The purification process of claim 2, wherein said mixed solution is a used cleaning solution spent once or more for cleaning and the used cleaning solution is regenerated by said purification process.

14. A purification apparatus used for the purification process of claim 2, the apparatus comprising
a water-soluble organic solvent removing device for performing said step (1),
an activated carbon filter for performing said step (2),
an activated alumina filter for performing said step (3), and
a particle removing filter for performing said step (4).
